(19) United States
(12) Patent Application Publication
(10) Pub. No.: US 2013/0300780 A1
(43) Pub. Date: Nov. 14, 2013

(54) DISPLAY DEVICE AND ELECTRICAL APPARATUS INCLUDING THE SAME

(71) Applicants: Shun Ueki, Osaka-shi (JP); Tomoko Teranishi, Osaka-shi (JP); Takuma Tomotoshi, Osaka-shi (JP); Toshiki Matsuoka, Osaka-shi (JP)

(72) Inventors: Shun Ueki, Osaka-shi (JP); Tomoko Teranishi, Osaka-shi (JP); Takuma Tomotoshi, Osaka-shi (JP); Toshiki Matsuoka, Osaka-shi (JP)

(73) Assignee: SHARP KABUSHIKI KAISHA, Osaka-shi, Osaka (JP)

(21) Appl. No.: 13/980,124

(22) PCT Filed: Jan. 12, 2012
(86) PCT No.: PCT/JP2012/050485

§ 371 Date: Jul. 17, 2013

(30) Foreign Application Priority Data
Jan. 18, 2011 (JP) 2011-007869

(51) Int. Cl. G09G 3/28

(52) U.S. Cl. CPC G09G 3/28
USPC 345/690; 345/212; 345/60

(57) ABSTRACT

In a display device (10) that includes an upper substrate (first substrate) (2), a lower substrate (second substrate) (3), and a polar liquid (16) and an oil (insulating fluid) (17) that are movable toward an effective display area (P1) or a non-effective display area (P2) in a display space (S) between the upper substrate (2) and the lower substrate (3), the contact angle θ0 of the polar liquid (16) in the oil (17) is 150 degrees or more and 180 degrees or less to a water-repellent film (surface film) (15).

### TECHNICAL FIELD

The present invention relates to a display device for displaying information, such as images and letters, through the movement of a polar liquid and to an electrical apparatus including the display device.

### BACKGROUND ART

In recent years, as exemplified by electrowetting display devices, display devices for displaying information utilizing a movement phenomenon of a polar liquid due to the external electric field have been developed and put to practical use.

More specifically, a known display device as described above includes a display space between first and second substrates and ribs (partitions) that divide the display space into pixel regions, as described in Patent Literature 1. Such a known display device contains an electrically conductive liquid (polar liquid) in each of the pixel regions and includes signal electrodes, scanning electrodes, and standard electrodes (reference electrodes). The signal electrodes cross the scanning electrodes and the standard electrodes, and the scanning electrodes and the standard electrodes are parallel to each other. In such a known display device, a voltage is applied to the signal electrode, the scanning electrode, and the standard electrode in each of the pixel regions to move the electrically conductive liquid toward the scanning electrode side or the standard electrode side, thereby changing the display color on the display surface side.

### CITATION LIST

### Patent Literature

PTL 1: International Publication No. WO 2008/155925 Pamphlet

### SUMMARY OF INVENTION

### Technical Problem

In order to improve mobility (movability or movement speed) of the electrically conductive liquid (polar liquid), such a known display device includes a water-repellent film, for example, made of a fluoropolymer, on a surface of each of the first and second substrates on the display space side. Upon application of a voltage, the water-repellent film becomes a hydrophilic layer to the electrically conductive liquid.

It is, however, difficult for such a known display device to further improve the mobility of the electrically conductive liquid.

In view of this problem, it is an object of the present invention to provide a display device that can further improve the mobility of a polar liquid and an electrical apparatus including the display device.

### Solution to Problem

In order to achieve the object, a display device according to the present invention includes a first substrate disposed on a display surface side, a second substrate disposed on a non-display surface side and facing the first substrate, the second substrate and the first substrate forming a predetermined display space therebetween, an effective display area and a non-effective display area in the display space, and a polar liquid that is movable toward the effective display area or the non-effective display area in the display space, wherein the polar liquid can be moved to change the display color on the display surface side. The display device further includes

a plurality of signal electrodes in contact with the polar liquid in the display space and arranged in a predetermined direction,

a plurality of scanning electrodes disposed on top of one of the first and second substrates on one of the effective display area side and the non-effective display area side, the scanning electrodes being electrically insulated from the polar liquid and crossing the signal electrodes,

an insulating fluid that is movable in the display space and is immiscible with the polar liquid, and

a surface film disposed on the display space side on top of one of the first and second substrates on which the scanning electrodes are disposed,

wherein the polar liquid in the insulating fluid has a contact angle of 150 degrees or more and 180 degrees or less to the surface film.

In such a display device, it was found that the friction between the polar liquid and the surface film can be greatly reduced when the polar liquid in the insulating fluid has a contact angle of 150 degrees or more and 180 degrees or less to the surface film. This can make the movement of the polar liquid smooth. The present invention has been accomplished on the basis of such findings and provides a display device that can further improve the mobility of a polar liquid.

In the display device, the surface film (F) and the insulating fluid (O) are preferably selected such that the interfacial energy γf/o between the surface film (F) and the insulating fluid (O) is 0 mN/m or more and less than 10 mN/m.

This can make it easy to set the contact angle at 150 degrees or more and 180 degrees or less and further improve the mobility of the movement speed of the polar liquid.

In the display device, the surface film (F), the insulating fluid (O), and the polar liquid (W) may be selected such that the interfacial energy γf/o between the surface film (F) and the insulating fluid (O) and the interfacial energy γf/w between the surface film (F) and the polar liquid (W) satisfy the following inequality (1).

γf/o≦0.134×γf/w (1)

This can make it easy to set the contact angle at 150 degrees or more and 180 degrees or less and further improve the mobility of the polar liquid.

In the display device, the insulating fluid (O) may be selected such that the interfacial energy γw/o between the insulating fluid and the polar liquid (W) and the interfacial energy γf/w between the surface film (F) and the polar liquid (W) satisfy the following inequality (2).

γw/o≦1.15×γf/w (2)

This can make it easy to set the contact angle at 150 degrees or more and 180 degrees or less and further improve the mobility of the polar liquid.

In the display device, the surface film (F) may be selected such that the difference between the surface tension γf/a,c between the surface film (F) and air (A) (wherein c denotes the critical surface tension of the surface film (F)) and the surface tension γo/a between the insulating fluid (O) and air (A) is within ±10 mN/m.

This can bring the surface energy of the surface film close to the surface energy of the insulating fluid and make it easy to set the contact angle at 150 degrees or more and 180 degrees or less.

In the display device, the insulating fluid (O) may be selected such that the difference between the surface tension γf/a,c between the surface film (F) and air (A) (wherein c denotes the critical surface tension of the surface film (F)) and the surface tension γo/a between the insulating fluid (O) and air (A) is within ±10 mN/m.

This can bring the surface energy of the insulating fluid close to the surface energy of the surface film and make it easy to set the contact angle at 150 degrees or more and 180 degrees or less.

In the display device, an additive agent that can be localized at an interface between the surface film and the insulating fluid may be added to the insulating fluid.

The additive agent allows the contact angle to be properly set at 150 degrees or more and 180 degrees or less and makes it more easy to further improve the mobility of the polar liquid.

The display device preferably further includes a signal voltage applicator that is connected to the signal electrodes and applies a signal voltage to each of the signal electrodes in a predetermined voltage range depending on information to be displayed on the display surface side, and

a scanning voltage applicator that is connected to the scanning electrodes and applies a selective voltage or a non-selective voltage to each of the scanning electrodes depending on the signal voltage, the selective voltage allowing the polar liquid to move in the display space, the non-selective voltage preventing the polar liquid from moving in the display space.

This allows the display color in each pixel region to be appropriately changed.

The display device may further include a plurality of pixel regions on the display surface side, wherein

the pixel regions are disposed at their respective intersections between the signal electrodes and the scanning electrodes, and the display space in the pixel regions is defined by partitions.

This allows the polar liquid to be moved in each pixel on the display surface side to change the display color on the display surface side in the individual pixels.

In the display device, the pixel regions may be provided for each of a plurality of colors for full-color display on the display surface side.

This allows the polar liquid in each of the pixels to be properly moved to produce color image display.

The display device preferably further includes a plurality of reference electrodes disposed on top of one of the first and second substrates on the other of the effective display area side and the non-effective display area side, the reference electrodes being electrically insulated from the polar liquid and the scanning electrodes and crossing the signal electrodes, and

a reference voltage applicator that is connected to the reference electrodes and applies a selective voltage or a non-selective voltage to each of the reference electrodes depending on the signal voltage, the selective voltage allowing the polar liquid to move in the display space, the non-selective voltage preventing the polar liquid from moving in the display space.

This can provide a matrix addressed display device that can prevent display defects without providing a switching element in each pixel region.

The display device preferably further includes a dielectric layer on the reference electrodes and the scanning electrodes.

In this case, electric charges on the dielectric layer can be reliably increased to ensure a further improvement in the mobility of the polar liquid.

In the display device, preferably, the non-effective display area is provided by a light-shielding film disposed on one of the first and second substrate sides, and

the effective display area is provided by an opening in the light-shielding film.

This can properly and reliably provide the effective display area and the non-effective display area in the display space.

An electrical apparatus according to the present invention is an electrical apparatus that includes a display screen for displaying information containing letters and an image and is characterized in that the display screen includes one of the display devices described above.

In such an electrical apparatus, the display screen includes a display device that can further improve the mobility of a polar liquid. Thus, it is easy to provide a high-performance electrical apparatus that includes a display screen having excellent display quality.

### Advantageous Effects of Invention

The present invention can provide a display device that can further improve the mobility of a polar liquid and an electrical apparatus including the display device.

### BRIEF DESCRIPTION OF DRAWINGS

FIG. 1 is a plan view of a display device and an image display apparatus according to a first embodiment of the present invention.

FIG. 2 is an enlarged plan view of a principal part on the upper substrate illustrated in FIG. 1 viewed from the display surface side.

FIG. 3 is an enlarged plan view of a principal part on the lower substrate illustrated in FIG. 1 viewed from the non-display surface side.

FIGS. 4(a) and 4(b) are cross-sectional views of a principal part of the display device illustrated in FIG. 1 in non-CF color display and CF color display, respectively.

FIG. 5(a) is a schematic view illustrating the contact angle of a polar liquid 16 in an oil 17 with respect to a water-repellent film 15 and the force applied to the polar liquid 16 in the absence of an applied electric field, FIG. 5(b) is a schematic view illustrating the force applied to the polar liquid 16 in the oil 17 disposed on the water-repellent film 15 in the presence of an applied electric field, and FIG. 5(c) is a schematic view illustrating a decrease in the interfacial energy between the water-repellent film 15 and the polar liquid 16 in the presence of an applied electric field.

FIG. 6 is a graph showing the relationship between the contact angle of the polar liquid 16 and the area of the surface in contact with the polar liquid 16.

FIG. 7 is a graph showing the relationship between γf/o (the interfacial energy between the water-repellent film 15 and the oil 17) and the contact angle of the polar liquid 16 in the system using the water-repellent film 15 of different types while the polar liquid 16 and the oil 17 in the display device are fixed with water and dodecane, respectively.

FIG. 8 is an explanatory view of an operation example of the image display apparatus.

FIG. 9 is a cross-sectional view of a principal part of a display device according to a second embodiment of the present invention.

FIG. 10 is a graph showing the relationship between the interfacial energy between a water-repellent film 25 and an oil 27 and the contact angle of a polar liquid 26 in the display device illustrated in FIG. 9 when the surface energy of the oil 27 is changed and the interfacial energy between the polar liquid 26 and the water-repellent film 25 is held constant.

FIG. 11 is a cross-sectional view of a principal part of a display device according to a third embodiment of the present invention.

FIG. 12 is an explanatory view of the state of a surfactant in the display device illustrated in FIG. 11.

### DESCRIPTION OF EMBODIMENTS

Preferred embodiments of a display device and an electrical apparatus according to the present invention will be described below with reference to the accompanying drawings. In the following description, the present invention is applied to an image display apparatus that includes a display screen for displaying color images. The dimensions of constructional members in the drawings are not the actual dimensions of the constructional members and the actual dimensional ratios of the constructional members.

### First Embodiment

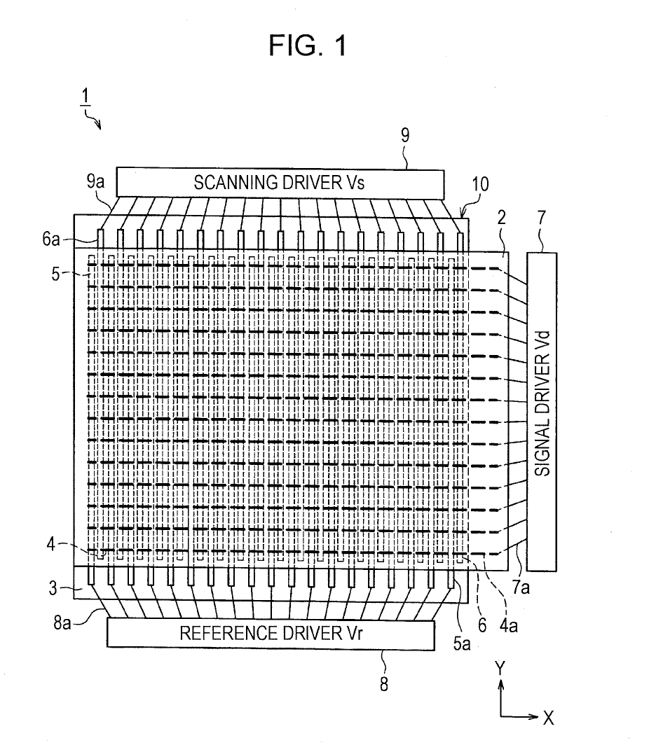

FIG. 1 is a plan view of a display device and an image display apparatus according to a first embodiment of the present invention. In FIG. 1, an image display apparatus 1 according to the present embodiment includes a display screen that includes a display device 10 according to the present invention. This display screen has a rectangular display surface. The display device 10 includes an upper substrate 2 and a lower substrate 3 overlapping each other in the direction perpendicular to the drawing. The overlap between the upper substrate 2 and the lower substrate 3 forms an effective display area on the display surface (as described in detail below).

The display device 10 also includes a plurality of signal electrodes 4 at predetermined intervals parallel to the X direction. The display device 10 also includes a plurality of reference electrodes 5 and a plurality of scanning electrodes 6 alternately disposed parallel to the Y direction. The signal electrodes 4 cross the reference electrodes 5 and the scanning electrodes 6. The display device 10 includes a plurality of pixel regions at their respective intersections between the signal electrodes 4 and the scanning electrodes 6.

A voltage in a predetermined voltage range between a first voltage or a high voltage (hereinafter referred to as an “H voltage”) and a second voltage or a low voltage (hereinafter referred to as an “L voltage”) can be independently applied to the signal electrodes 4, the reference electrodes 5, and the scanning electrodes 6 (as described in detail below).

As described in detail below, the pixel regions in the display device 10 are separated by partitions and are provided for each of a plurality of colors for full-color display on the display surface side. In the display device 10, a polar liquid described below is moved owing to an electrowetting phenomenon to change the display color on the display surface side in each of a matrix of pixels (display cells).

An end of each of the signal electrodes 4, the reference electrodes 5, and the scanning electrodes 6 protrudes from the effective display area of the display surface to form terminals 4a, 5a, and 6a.

The terminals 4a of the signal electrodes 4 are connected to a signal driver 7 through electric wires 7a. The signal driver 7 constitutes a signal voltage applicator. When the image display apparatus 1 displays information containing letters and an image on the display surface, the signal driver 7 applies a signal voltage Vd depending on the information to the signal electrodes 4.

The terminals 5a of the reference electrodes 5 are connected to a reference driver 8 through electric wires 8a. The reference driver 8 constitutes a reference voltage applicator. When the image display apparatus 1 displays information containing letters and an image on the display surface, the reference driver 8 applies a reference voltage Vr to the reference electrodes 5.

The terminals 6a of the scanning electrodes 6 are connected to a scanning driver 9 through electric wires 9a. The scanning driver 9 constitutes a scanning voltage applicator. When the image display apparatus 1 displays information containing letters and an image on the display surface, the scanning driver 9 applies a scanning voltage Vs to the scanning electrodes 6.

The scanning driver 9 applies a non-selective voltage or a selective voltage to each of the scanning electrodes 6 as the scanning voltage Vs. The non-selective voltage prevents the polar liquid from moving, and the selective voltage allows the polar liquid to move in response to the signal voltage Vd. The reference driver 8 operates with reference to the operation of the scanning driver 9. The reference driver 8 applies a non-selective voltage or a selective voltage to each of the reference electrodes 5 as the reference voltage Vr. The non-selective voltage prevents the polar liquid from moving, and the selective voltage allows the polar liquid to move in response to the signal voltage Vd.

In the image display apparatus 1, the scanning driver 9 sequentially applies a selective voltage to each of the scanning electrodes 6, for example, from left to right in FIG. 1, and the reference driver 8 sequentially applies a selective voltage to each of the reference electrodes 5 from left to right in FIG. 1 in synchronism with the operation of the scanning driver 9. Thus, scanning operation is performed from one line to another (as described in detail below).

The signal driver 7, the reference driver 8, and the scanning driver 9 include a direct-current power supply or an alternating-current power supply and supply a signal voltage Vd, a reference voltage Vr, and a scanning voltage Vs, respectively.

The reference driver 8 changes the polarity of the reference voltage Vr at intervals of a predetermined time (for example, 1 frame). The scanning driver 9 changes the polarity of the scanning voltage Vs in response to a change in the polarity of the reference voltage Vr. Thus, the polarities of the reference voltage Vr and the scanning voltage Vs are changed at intervals of the predetermined time. This can prevent electric charges from being localized in the reference electrodes 5 and the scanning electrodes 6 as compared with the case where a voltage of the same polarity is continuously applied to the reference electrodes 5 and the scanning electrodes 6. This can also prevent adverse effects resulting from the localization of electric charges, such as display defects (an image retention phenomenon) and reliability (a decrease in life).

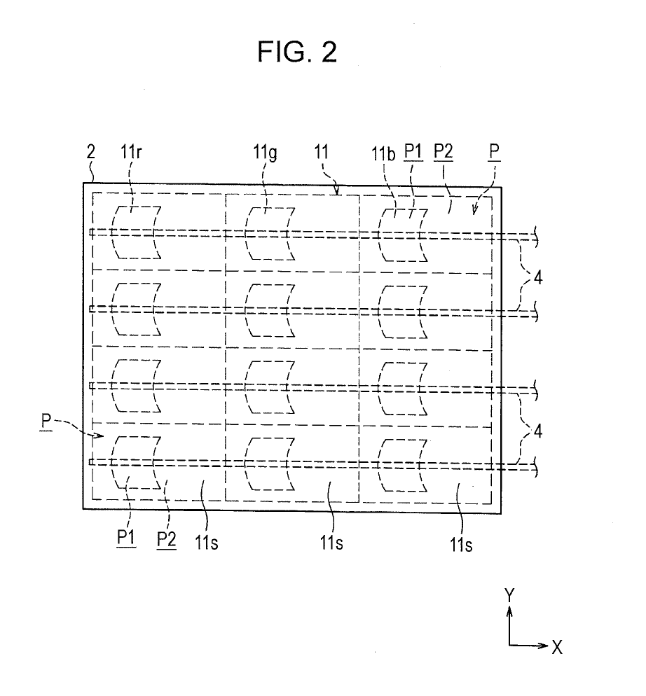

Referring also to FIGS. 2 to 4, the pixel structure of the display device 10 will be more specifically described.

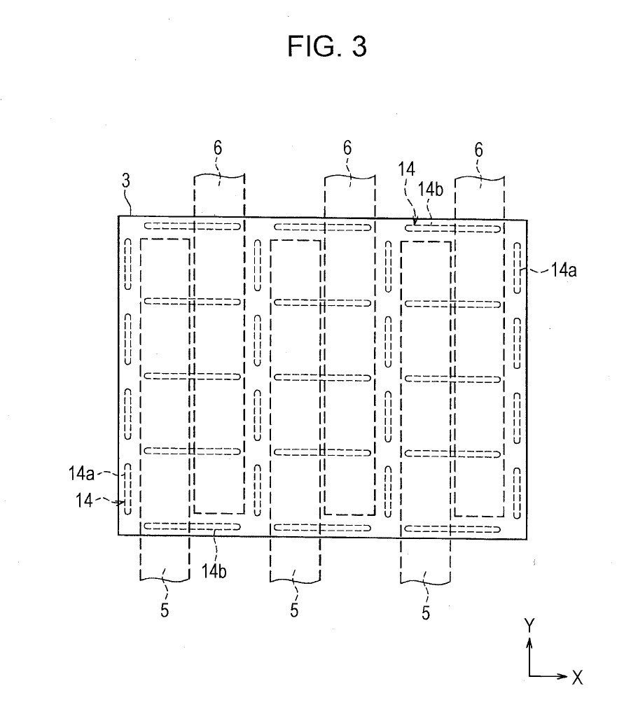

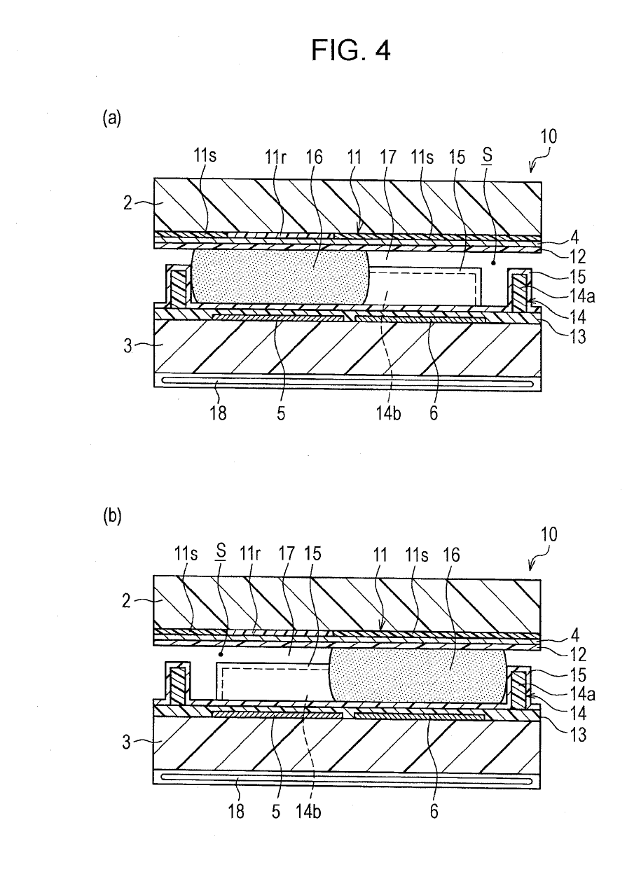

FIG. 2 is an enlarged plan view of a principal part on the upper substrate illustrated in FIG. 1 viewed from the display surface side. FIG. 3 is an enlarged plan view of a principal part on the lower substrate illustrated in FIG. 1 viewed from the non-display surface side. FIGS. 4(a) and 4(b) are cross-sectional views of a principal part of the display device illustrated in FIG. 1 in non-CF color display and CF color display, respectively. In FIGS. 2 and 3, for the sake of simplicity, among the pixels on the display surface, 12 pixels in the upper left of FIG. 1 are illustrated.

In FIGS. 2 to 4, the display device 10 includes the upper substrate 2 as a first substrate on the display surface side and the lower substrate 3 as a second substrate on the back side (non-display surface side) of the upper substrate 2. The display device 10 also includes a predetermined display space S between the upper substrate 2 and the lower substrate 3 disposed at a predetermined interval. The display space S contains a polar liquid 16 and an oil 17, which is an insulating fluid immiscible with the polar liquid 16. The polar liquid 16 and the oil 17 can move in the X direction (the horizontal direction in FIG. 2) and can move toward an effective display area P1 or a non-effective display area P2 described below.

In the display device 10 according to the present embodiment, in order to further improve the mobility of the polar liquid 16, the contact angle of the polar liquid 16 in the oil (insulating fluid (O)) 17 is 150 degrees or more and 180 degrees or less to a water-repellent film (surface film (F)) 15, as described in detail below.

The polar liquid 16 is pure water, for example. The polar liquid 16 is of a predetermined color, for example, black with a self-dispersing pigment.

The black polar liquid 16 functions as a shutter for allowing or preventing light transmission in each pixel. In the pixels of the display device 10, the polar liquid 16 slides toward the reference electrode 5 (the effective display area P1) or the scanning electrode 6 (the non-effective display area P2) in the display space S to change the display color to black or one of RGB, as described in detail below.

The oil 17 may be a nonpolar colorless transparent oil composed of at least one selected from side-chain higher alcohols, side-chain higher fatty acids, alkane hydrocarbons, silicone oil, and matching oil. The oil 17 can move in the display space S as the polar liquid 16 slides.

The upper substrate 2 may be a transparent glass substrate, such as a non-alkali glass substrate, or a transparent sheet of a transparent synthetic resin, such as an acrylic resin. A color filter layer 11 and the signal electrodes 4 are disposed on the non-display surface of the upper substrate 2 in this order. The color filter layer 11 and the signal electrodes 4 are covered with a water-repellent film 12.

As in the upper substrate 2, the lower substrate 3 may be a transparent glass substrate, such as a non-alkali glass substrate, or a transparent sheet of a transparent synthetic resin, such as an acrylic resin. The reference electrodes 5 and the scanning electrodes 6 are disposed on the display surface of the lower substrate 3 and are covered with a dielectric layer 13. Ribs 14 are disposed on the display surface of the dielectric layer 13. The ribs 14 include first rib members 14a parallel to the Y direction and second rib members 14b parallel to the X direction. The dielectric layer 13 and the ribs 14 on the lower substrate 3 are covered with the water-repellent film 15. The water-repellent film 15 constitutes the surface film (F) disposed on the display space S side of the lower substrate 3 on which the reference electrodes 5 and the scanning electrodes 6 are disposed.

A backlight 18, for example, for emitting white illumination light is integrally disposed on the back side (non-display surface side) of the lower substrate 3, thus constituting the display device 10 of a transmissive type. The backlight 18 may be a light source, such as a cold cathode fluorescent tube or LED.

The color filter layer 11 includes color filters 11r, 11g, and 11b of red (R), green (G), and blue (B), respectively, and a black matrix 11s as a light-shielding film, thus constituting RGB pixels. More specifically, as illustrated in FIG. 2, the color filter layer 11 includes the RGB color filters 11r, 11g, and 11b arranged in this order in the X direction, and four lines of the color filters 11r, 11g, and 11b are arranged in the Y direction. Three color filters in the X direction and four lines of the color filters in the Y direction yield 12 pixels in total.

As illustrated in FIG. 2, each pixel region P of the display device 10 includes the RGB color filter 11r, 11g, or 11b in the effective display area P1 and the black matrix 11s in the non-effective display area P2. Thus, for the display space S in the display device 10, the black matrix (light-shielding film) 11s constitutes the non-effective display area P2 (non-opening), and an opening (the color filter 11r, 11g, or 11b) in the black matrix 11s constitutes the effective display area P1.

In the display device 10, each of the color filters 11r, 11g, and 11b has an area slightly smaller than or equal to the area of the effective display area P1. The black matrix 11s has an area slightly larger than or equal to the area of the non-effective display area P2. Although a borderline between two black matrices 11s of adjacent pixels is indicated by a dotted line in FIG. 2 in order to clarify the boundary between the adjacent pixels, the color filter layer 11 actually has no borderline between the black matrices 11s.

In the display device 10, the display space S is divided by the ribs 14 serving as the partitions into the pixel regions P. More specifically, as illustrated in FIG. 3, the display space S of each pixel in the display device 10 is defined by two opposite first rib members 14a and two opposite second rib members 14b. The ribs 14a and 14b in the display device 10 prevent the polar liquid 16 from flowing into display spaces S of adjacent pixel regions P. The first and second rib members 14a and 14b are made of an epoxy resin resist material, for example. The first and second rib members 14a and 14b have a predetermined height (rib height) with respect to the dielectric layer 13 so as to prevent the inflow and outflow of the polar liquid 16 between adjacent pixels.

Although each of the ribs 14 has a space at its four corners in the above description, the present invention is not limited to this structure. For example, a frame rib may be used.

The water-repellent films 12 and 15 are made of a transparent synthetic resin, preferably a transparent synthetic resin that becomes a hydrophilic layer to the polar liquid 16 upon voltage application, for example, a fluoropolymer. This can greatly alter the wettability (contact angle) between the polar liquid 16 and the surfaces of the upper substrate 2 and the lower substrate 3 on the display space S side in the display device 10, thereby increasing the movement speed of the polar liquid 16. For example, the dielectric layer 13 is composed of a transparent dielectric film containing parylene, silicon nitride, hafnium oxide, zinc oxide, titanium dioxide, or aluminum oxide. Each of the water-repellent films 12 and 15 has a thickness in the range of several tens of nanometers to several micrometers. The dielectric layer 13 has a thickness of several hundreds of nanometers. The water-repellent film 12 does not electrically insulate the signal electrodes 4 from the polar liquid 16 and does not hinder the improvement in responsivity of the polar liquid 16.

As described above, the water-repellent film 15 constitutes the surface film (F). In the display device 10 according to the present embodiment, the surface energy of the water-repellent film 15 is brought close to the surface energy of the oil (insulating fluid (O)) 17 to set the contact angle of the polar liquid 16 at 150 degrees or more and 180 degrees or less, as described in detail below. The water-repellent film 15 and the oil 17 are selected such that the interfacial energy γf/o between the water-repellent film 15 and the oil 17 is 0 mN/m or more and less than 10 mN/m (as described in detail below).

The reference electrodes 5 and the scanning electrodes 6 are made of a transparent electrode material, such as indium oxide (ITO), tin oxide (SnO₂), or zinc oxide (AZO, GZO, or IZO). The reference electrodes 5 and the scanning electrodes 6 are arranged in stripes on the lower substrate 3 by a known film-forming method, such as sputtering.

The signal electrodes 4 are linear electric wires parallel to the X direction. The signal electrodes 4 are made of a transparent electrode material, such as ITO. Each of the signal electrodes 4 on the color filter layer 11 passes through substantially the vertical center of the pixel region P and is electrically connected to the polar liquid 16 via the water-repellent film 12. This can improve the responsivity of the polar liquid 16 of the display device 10 in display operation.

In each pixel of the display device 10 having the structure as described above, when the polar liquid 16 is disposed between the color filter 11r and the reference electrode 5, as illustrated in FIG. 4(a), the polar liquid 16 blocks light from the backlight 18 to produce black display (non-CF color display). When the polar liquid 16 is disposed between the black matrix 11s and the scanning electrode 6, as illustrated in FIG. 4(b), light from the backlight 18 is not blocked by the polar liquid 16 and passes through the color filter 11r, thereby producing red display (CF color display).

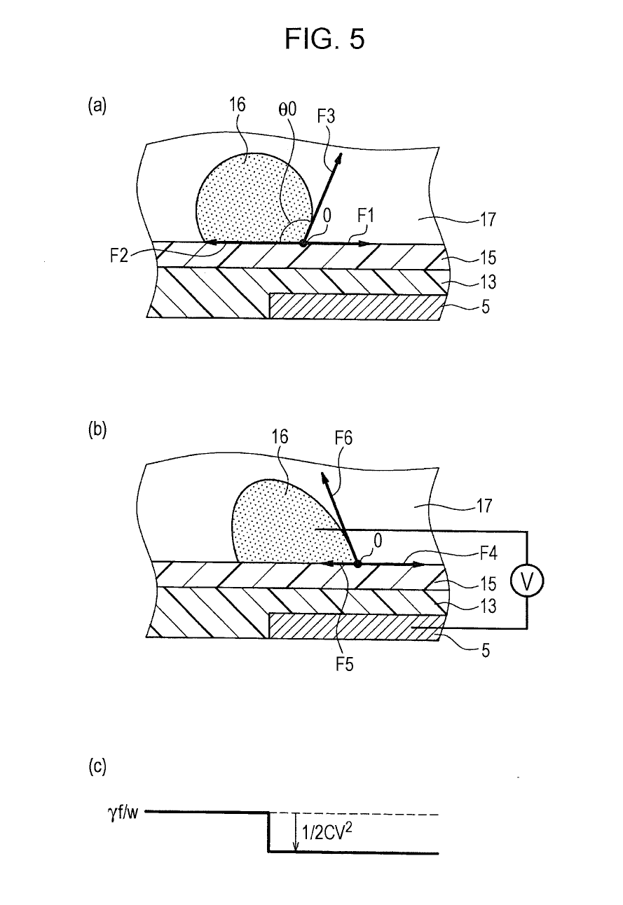

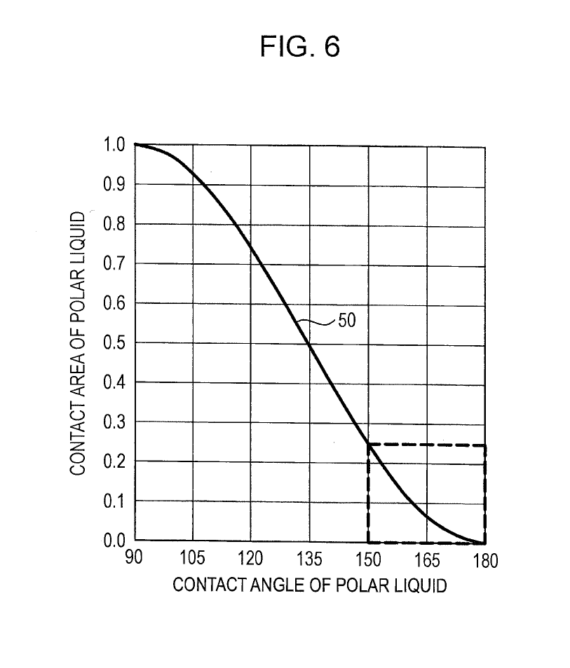

Referring also to FIGS. 5 to 6, the water-repellent film 15, the polar liquid 16, and the oil 17 according to the present embodiment will be more specifically described.

FIG. 5(a) is a schematic view illustrating the contact angle of a polar liquid 16 in an oil 17 on a water-repellent film 15 and the force applied to the polar liquid 16 in the absence of an applied electric field, FIG. 5(b) is a schematic view illustrating the force applied to the polar liquid 16 in the oil 17 disposed on the water-repellent film 15 in the presence of an applied electric field, and FIG. 5(c) is a schematic view illustrating a decrease in the interfacial energy between the water-repellent film 15 and the polar liquid 16 in the presence of an applied electric field. FIG. 6 is a graph showing the relationship between the contact angle of the polar liquid 16 and the area of the surface in contact with the polar liquid 16. In FIGS. 5(a) and 5(b), for the sake of simplicity, the signal electrodes 4 and the scanning electrodes 6 are omitted.

The polar liquid 16 on the lower substrate 3 in which an electrowetting phenomenon occurs will be described below with reference to FIGS. 5(a) to 5(c).

In FIG. 5(a), in the absence of an electric field applied to the polar liquid 16, the following three interfacial energies γf/o, γf/w, and γw/o act on the polar liquid 16 at a contact point O between the water-repellent film 15 and the oil 17 (that is, an interface between the water-repellent film 15, the polar liquid 16, and the oil 17). More specifically, as indicated by an arrow F1 in FIG. 5(a), the interfacial energy γf/o between the water-repellent film 15 (surface film (F)) and the oil 17 (insulating fluid (O)) acts on the polar liquid 16 at the contact point O. Furthermore, as indicated by an arrow F2 in FIG. 5(a), the interfacial energy γf/w between the water-repellent film 15 (surface film (F)) and the polar liquid 16 (polar liquid (W)) acts on the polar liquid 16 at the contact point O, and as indicated by an arrow F3 in FIG. 5(a), the interfacial energy γw/o between the polar liquid 16 (polar liquid (W)) and the oil 17 (insulating fluid (O)) acts on the polar liquid 16 at the contact point O.

The following Young equation (I) holds at the contact point O, wherein θ0 denotes the contact angle of the polar liquid 16 in the oil 17 with respect to the water-repellent film 15.

γf/o=γf/w+γw/o×cos θ0 (I)

In the absence of an electric field applied to the polar liquid 16, as illustrated in FIG. 5(a), the polar liquid 16 is a stationary droplet having a contact angle θ0, and the wettability of the polar liquid 16 depends on the magnitude relationship between the three interfacial energies γf/o, γf/w, and γw/o.

As illustrated in FIG. 5(b), when a voltage is applied to the signal electrode 4 (not shown) and the reference electrode 5, and an electric field V is applied to the polar liquid 16, the interfacial energy γf/w is reduced by the electric charges stored in the dielectric layer 13. Thus, as indicated by an arrow F4 in FIG. 5(b), an interfacial energy γf/o,v=γf/o between the water-repellent film 15 and the oil 17 in the presence of the electric field V acts at the contact point O, and as indicated by an arrow F6 in FIG. 5(b), an interfacial energy γw/o,v=γw/o between the polar liquid 16 and the oil 17 in the presence of the electric field V acts at the contact point O. Furthermore, as indicated by an arrow F5 in FIG. 5(b), an interfacial energy γf/w,v between the water-repellent film 15 and the polar liquid 16 in the presence of the electric field V acts at the contact point O. As described above, the interfacial energy γf/w,v is lower by the electric charges stored in the dielectric layer 13 and is stabilized by ½CV² as illustrated in FIG. 5(c), wherein C denotes the capacitance of the dielectric layer 13.

More specifically, the interfacial energy γf/w,v is expressed by the following Lippmann equation (II).

γf/w,v=γf/w−½CV² (II)

Thus, upon application of an electric field V to the polar liquid 16 on the dielectric layer 13, a surface having a high affinity (highly wettable surface) for the polar liquid 16 is formed on the water-repellent film 15. As illustrated in FIG. 5(b), the polar liquid 16 as a fluid therefore moves or changes its shape so as to increase the contact area with the surface having a high affinity. This is the electrowetting phenomenon.

Thus, in order to smoothly move the polar liquid 16 through the electrowetting phenomenon, the polar liquid 16 should not spread over the water-repellent film 15 and should have a large contact angle θ0 to form a droplet in the absence of an applied electric field, thereby decreasing the friction between the polar liquid 16 and the water-repellent film 15. Preferably, the contact angle θ0 of the polar liquid 16 in the oil 17 is close to 180 degrees. As a result of various experiments and simulations, the present inventors found that the polar liquid 16 can move smoothly when the contact angle θ0 of the polar liquid 16 in the oil 17 is 150 degrees or more to the water-repellent film 15.

When the contact angle θ0 is 150 degrees or more and 180 degrees or less, the wetted surface area of the polar liquid 16 disposed on the water-repellent film 15 is sufficiently small. Thus, the present inventors can make the surface of the water-repellent film 15 to function as a slide surface on which the polar liquid 16 can move smoothly. More specifically, when the polar liquid 16 forms a spherical cap having a radius r on the water-repellent film 15, and a spherical cap (hemisphere) having the radius r and a contact angle θ0 of 90 degrees has a wetted surface area (πr²) of one, as shown by a curved line 50 in FIG. 6, a contact angle θ0 of 150 degrees or more results in a very small wetted surface area of 0.25 or less. Thus, the polar liquid 16 could move smoothly.

An experiment of the present inventors demonstrated that a contact angle θ0 of 150 degrees or more resulted in smooth movement of the polar liquid 16 and a further improvement in the mobility of the polar liquid 16. The following Table 1 shows one example of specific experimental results.

TABLE 1

| Contact angle θ0 (degrees) | Movement of polar liquid |
|---|---|
| 92 | x |
| 112 | x |
| 120 | x |
| 128 | x |
| 134 | x |
| 144 | x |
| 150 | ∘ |
| 155 | ∘ |
| 160 | ∘ |
| 161 | ∘ |
| 168 | ∘ |

In the experimental example described above, a fluorine film was formed as the water-repellent film 15 on top of the glass substrate, and the signal electrode 4, the reference electrode 5, and the scanning electrode 6 were disposed in a region surrounded by the first and second rib members 14a and 14b to constitute a display device corresponding to one pixel. The polar liquid 16 was a liquid mixture of water and ethylene glycol in equal proportions. The oil 17 was decane. An active nonionic surfactant was added to the interface between the polar liquid 16 and the oil 17 to control the contact angle θ0 of the polar liquid 16. Eleven experimental liquids (polar liquids 16) having different contact angles θ0 were prepared, as shown in Table 1. While a 20 Vpp rectangular pulse was applied to the signal electrode 4 and the scanning electrode 6, the behavior of the polar liquid 16 was observed. Movement of the polar liquid 16 to the reference electrode 5 upon the application of the pulse was regarded as success (a circle), and deformation of the polar liquid 16 without movement or response was regarded as fail (a cross mark).

As is clear from Table 1, when the contact angle θ0 of the polar liquid 16 was 150 degrees or more, the polar liquid 16 moved smoothly. In contrast, when the contact angle θ0 was 144 degrees or less, the polar liquid 16 did not move.

When the contact angle θ0 is 150 degrees or more, cos θ0≦−(√3/2) holds. The equation (I) can be transformed into the following formula (III).

γf/o≦γf/w−(√3/2)×γw/o (III)

The present inventors focused on a decrease in interfacial energy γf/o in the formula (III). More specifically, the present inventors found that the interfacial energy γf/o can be decreased to effectively induce the electrowetting phenomenon, thereby further improving the mobility of the polar liquid 16, without using a surface film having a low affinity for the polar liquid 16 as a surface film in contact with the polar liquid 16, that is, without using the water-repellent film 15 having high water repellency.

More specifically, the study by the present inventors demonstrated that when the water-repellent film (surface film (F)) 15 and the oil (insulating fluid (O)) 17 are selected such that the interfacial energy γf/o is 0 mN/m or more and less than 10 mN/m it is easy to set the contact angle θ0 at 150 degrees or more and 180 degrees or less and further improve the mobility of the polar liquid 16.

Such a sufficiently low interfacial energy γf/o indicates that the characteristics of the water-repellent film 15 approach the characteristics of the oil 17, and an approximate expression of γw/o≈γf/w can easily hold. Using this approximate expression, the formula (III) can be transformed to the following inequality (1).

γf/o≦(2−√3)/2×γf/w

γf/o≦0.134×γf/w (1)

In the display device 10, when the water-repellent film 15, the polar liquid 16, and the oil 17 are selected so as to satisfy the inequality (1), it is easy to set the contact angle θ0 at 150 degrees or more and 180 degrees or less and further improve the mobility of the polar liquid 16.

In consideration of the conditions for bringing the interfacial energy γf/o close to “0” in the formula (III), that is, the conditions required for the oil 17 in an approximate expression of γf/o≈0, the following inequality (2) can be derived from the formula (III).

γw/o≦2/√3×γf/w

γw/o≦1.15×γf/w (2)

Thus, when the oil 17 has an interfacial energy γw/o of 1.15 times or less higher than the interfacial energy γf/w, it is easy to set the contact angle θ0 at 150 degrees or more and 180 degrees or less and further improve the mobility of the polar liquid 16.

The characteristics of the water-repellent film 15 can approach the characteristics of the oil 17, for example, by selecting the materials of the water-repellent film 15 and the oil 17 such that the surface tensions (interfacial energies) γf/a,c and γo/a with respect to air (A) are close to each other. The γf/a,c is the critical surface tension of the solid. According to the Zisman method, γf/a,c can be determined by dropping droplets having different interfacial tensions (interfacial energies) onto a solid surface and determining the surface tension of a liquid having a contact angle θ0 of “0” by extrapolation.

The following Table 2 shows the approximate surface tensions γf/a,c and γo/a of materials for use in the water-repellent film 15 and the oil 17.

TABLE 2

| Water-repellent film | γf/a, c | Oil | γo/a |
|---|---|---|---|
| Polytetrafluoroethylene | 18 (mN/m) | Perfluorooctane | 14 (mN/m) |
| (PTFE) | | Hydrofluoroether | 17 (mN/m) |
| Polymethylpentene | 24 (mN/m) | Silicone | 21 (mN/m) |
| Polypropylene | 29 (mN/m) | Ethyl acetate | 26 (mN/m) |
| Polyethylene | 31 (mN/m) | Dodecane | 27 (mN/m) |
| Poly(vinyl fluoride) | 32 (mN/m) | Cyclohexane | 28 (mN/m) |
| Polystyrene | 38 (mN/m) | Chloroform | 30 (mN/m) |
| Acrylic resin | 40 (mN/m) | p-xylene | 31 (mN/m) |
| Poly(ethylene | 40 (mN/m) | Toluene | 36 (mN/m) |
| terephthalate) (PET) | | Benzaldehyde | 41 (mN/m) |
| Methacrylate resin | 42 (mN/m) | | |
| (PMMA) | | | |
| Nylon-6 | 46 (mN/m) | | |

The materials can have different surface tensions γf/a,c and γo/a owing to the presence of a fluorine atom or a hydrophilic group. In the display device 10 according to the present embodiment, the water-repellent film 15 is selected such that the difference between its surface tension γf/a,c and the surface tension γo/a of the oil 17 is within ±10 mN/m. Thus, in the display device 10 according to the present embodiment, the surface energy of the water-repellent film 15 is brought close to the surface energy of the oil 17 to easily set the contact angle θ0 at 150 degrees or more and 180 degrees or less.

More specifically, for example, when the oil 17 is dodecane (γo/a=27 mN/m), the water-repellent film 15 is selected to have γf/a,c in the range of 17 to 37 mN/m. In the examples of Table 2, the water-repellent film 15 may be polytetrafluoroethylene, polymethylpentene, polypropylene, polyethylene, or poly(vinyl fluoride). Since a thermosetting resin or a photocurable resin, such as polyethylene or poly(vinyl fluoride), can be used, the present embodiment can provide the display device 10 for electrowetting in which the polar liquid 16 can move smoothly, without using an expensive fluorine-rich water-repellent film material that is difficult to apply to a glass substrate surface, such as polytetrafluoroethylene, in the water-repellent film 15.

Apart from the above description, for example, the water-repellent film 15 on a glass substrate surface may be treated with a silane, such as 1-chlorooctadecyltrichlorosilane (Cl₃Si—(CH₂)₁₇—CH₂Cl), octadecyltrichlorosilane (Cl₃Si—(CH₂)₁₇—CH₃), or heptadecafluoro 1,1,2,2,-tetrahydrodecyltrichlorosilane (Cl₃Si—(CH₂)₁₀—(CF₂)₇—CF₃).

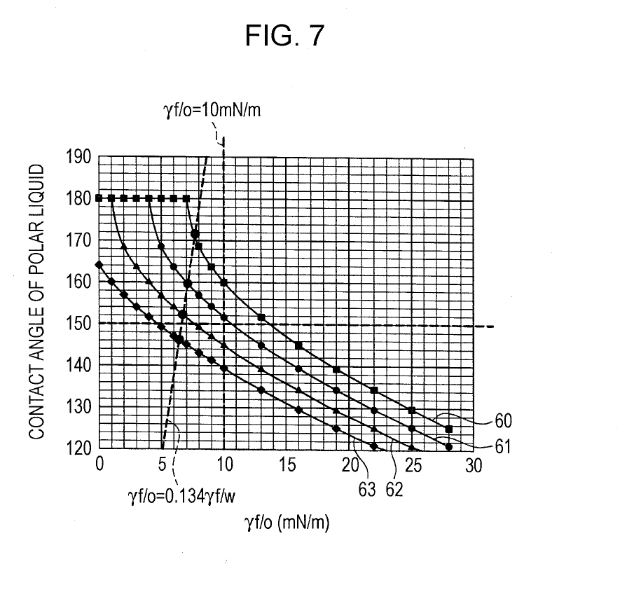

An example of experimental results for the display device 10 according to the present embodiment implemented by the present inventors will be more specifically described with reference to FIG. 7.

FIG. 7 is a graph showing the relationship between γf/o (the interfacial energy between the water-repellent film 15 and the oil 17) and the contact angle of the polar liquid 16 in the system using the water-repellent film 15 of different types while the polar liquid 16 and the oil 17 in the display device are fixed with water and dodecane, respectively. The interfacial energy γw/o between the polar liquid 16 and the oil 17 is held constant at 50 mN/m.

In this case, the contact angle in the system of the polar liquid 16 is calculated assuming four water-repellent films having different γf/w values as the water-repellent film 15 (curves 60, 61, 62, and 63).

When a fluorine-containing polymer having a fluorine atom in its structure (more specifically, polytetrafluoroethylene) was used as the water-repellent film 15, the interfacial energy γf/w between the water-repellent film and the polar liquid was 54 mN/m (curve 61). In this case, the surface energy of the water-repellent film 15 approaches the surface energy of the oil 17. A sufficiently low interfacial energy γf/o between the water-repellent film 15 and the oil 17 results in a large contact angle θ0 of the polar liquid 16 and an improvement in the mobility of the polar liquid.

More specifically, when the interfacial energy γf/o is 10.6 mN/m, the contact angle θ0 is 150 degrees or more. When the interfacial energy γf/o is 7.1 mN/m, the contact angle θ0 is 160 degrees or more.

The fluorine atom content of the fluorine-containing polymer of the water-repellent film 15 was changed such that the interfacial energy γf/w was higher or lower than 54 mN/m, that is, 57, 51, or 48 mN/m. The curves 60, 62, and 63 show simulation results. A high fluorine atom content results in a high interfacial energy γf/w, whereas a low fluorine atom content results in a low γf/w. The curve 63 is based on the assumption that the polymer has a low fluorine content. Even without using a fluorine-rich polymer in the water-repellent film 15, the interfacial energy γf/o can be sufficiently decreased to 4.7 mN/m or less to set the contact angle at 150 degrees or more. The fluorine content of the water-repellent film 15 can be decreased to bring the surface energy of the water-repellent film 15 close to the surface energy of the oil 17, thereby realizing a low γf/o.

As is clear from the curves 60 to 63, when the interfacial energy γf/o is as low as less than 10 mN/m, the contact angle θ0 can be more easily set at 150 degrees or more. As illustrated in FIG. 7, when the water-repellent film 15 is selected such that γf/o is 0.134 times or less of γf/w, the contact angle θ0 can be more reliably set at 150 degrees or more.

At this time, considering and referring to the type of the water-repellent film 15 and the magnitude of the surface energy γo/a of the oil 17, the water-repellent film 15 may be selected such that γf/a,c comes as close as possible to γo/a. Since the oil 17 is dodecane in the present embodiment, γo/a is 27 mN/m. Thus, the water-repellent film 15 may be polymethylpentene, which has γf/a,c close to the γo/a. Such selection of the material can reduce the interaction between the water-repellent film 15 and the oil 17 to realize a low γf/o. Thus, even a polymer containing no fluorine atom may be used in the water-repellent film 15 of the present embodiment.

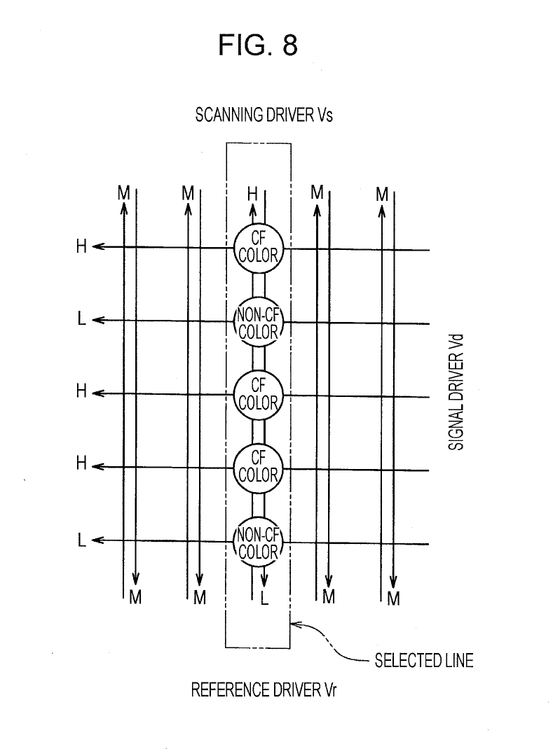

Referring also to FIG. 8, the display operation of the image display apparatus 1 according to the present embodiment having such a structure will be more specifically described below.

FIG. 8 is an explanatory view of an operation example of the image display apparatus.

In FIG. 8, the reference driver 8 and the scanning driver 9 sequentially apply the selective voltages as the reference voltage Vr and the scanning voltage Vs to the reference electrodes 5 and the scanning electrodes 6 in a predetermined scanning direction, for example, from left to right in the drawing. More specifically, the reference driver 8 and the scanning driver 9 sequentially apply an H voltage (a first voltage) and an L voltage (a second voltage) as the selective voltages to the reference electrodes 5 and the scanning electrodes 6, thereby sweeping the selected line. In the selected line, the signal driver 7 applies the H voltage or the L voltage as the signal voltage Vd to the corresponding signal electrode 4 in response to the external image input signal. Thus, the polar liquid 16 in each pixel in the selected line moves toward the effective display area P1 or the non-effective display area P2 to change the display color on the display surface side.

The reference driver 8 and the scanning driver 9 apply the non-selective voltages as the reference voltage Vr and the scanning voltage Vs to unselected lines, that is, the remainder of the reference electrodes 5 and the scanning electrodes 6. For example, the reference driver 8 and the scanning driver 9 apply a middle voltage (hereinafter referred to as an “M voltage”) as the non-selective voltage to the remainder of the reference electrodes 5 and the scanning electrodes 6. The middle voltage is an intermediate voltage between the H voltage and the L voltage. Thus, the polar liquid 16 in each pixel in the unselected lines remains at rest in the effective display area P1 or the non-effective display area P2 without causing unnecessary fluctuations and does not change the display color on the display surface side.

Table 1 shows combinations of voltages applied to the reference electrodes 5, the scanning electrodes 6, and the signal electrodes 4 in such display operation. As shown in Table 3, the behavior of the polar liquid 16 and the display color on the display surface side depend on the applied voltage. In Table 1, the H voltage, the L voltage, and the M voltage are abbreviated to “H”, “L”, and “M”, respectively (the same applies to Table 4). For example, the H voltage, the L voltage, and the M voltage are +16, 0, and +8 V, respectively.

TABLE 3

| | | | | Behavior of polar liquid |
|---|---|---|---|---|
| | Reference | Scanning | Signal | and display color on |
| | electrode | electrode | electrode | display surface side |
| Selected | H | L | H | Move toward scanning |
| line | | | | electrode |
| | | | | CF color display |
| | | | L | Move toward reference |
| | | | | electrode |
| | | | | Black display |
| Un- | M | M | H | At rest (No movement) |
| selected | | | L | Black or CF color |
| line | | | | display |

### <Operation in Selected Line>

When the H voltage is applied to the signal electrode 4 in the selected line, the H voltage is also applied between the reference electrode 5 and the signal electrode 4. Thus, no potential difference exists between the reference electrode 5 and the signal electrode 4. On the other hand, since the L voltage is applied to the scanning electrode 6, a potential difference exists between the signal electrode 4 and the scanning electrode 6. Thus, the polar liquid 16 moves in the display space S toward the scanning electrode 6, which has a potential difference from the signal electrode 4. Thus, the polar liquid 16 moves to the non-effective display area P2, as illustrated in FIG. 4(b). This moves the oil 17 toward the reference electrode 5 and allows illumination light of the backlight 18 to reach the color filter 11r. Thus, the display color on the display surface side is red display (CF color display) due to the color filter 11r. In the image display apparatus 1, when the polar liquid 16 in adjacent three RGB pixels moves to the non-effective display area P2 and produces CF color display, red light, green light, and blue light of the RGB pixels are mixed to form white light, thereby producing white display.

When the L voltage is applied to the signal electrode 4 in the selected line, a potential difference exists between the reference electrode 5 and the signal electrode 4, and no potential difference exists between the signal electrode 4 and the scanning electrode 6. Thus, the polar liquid 16 moves in the display space S toward the reference electrode 5, which has a potential difference from the signal electrode 4. Thus, the polar liquid 16 moves to the effective display area P1, as illustrated in FIG. 4(a), and prevents illumination light of the backlight 18 from reaching the color filter 11r. Thus, the display color on the display surface side is black display (non-CF color display) due to the polar liquid 16.

### <Operation in Unselected Line>

When the H voltage is applied to the signal electrodes 4 in the unselected lines, the polar liquid 16 remains at rest and maintains the display color. More specifically, since the M voltage is applied to the reference electrodes 5 and the scanning electrodes 6, the potential difference between the reference electrodes 5 and the signal electrodes 4 is the same as the potential difference between the scanning electrodes 6 and the signal electrodes 4. Thus, the display color is not changed from black display or CF color display.

Likewise, when the L voltage is applied to the signal electrodes 4 in the unselected lines, the polar liquid 16 remains at rest and maintains the display color. More specifically, since the M voltage is applied to the reference electrodes 5 and the scanning electrodes 6, the potential difference between the reference electrodes 5 and the signal electrodes 4 is the same as the potential difference between the scanning electrodes 6 and the signal electrodes 4.

Thus, whether the signal electrodes 4 in the unselected lines have the H voltage or the L voltage, the polar liquid 16 remains at rest, and the display color on the display surface side remains unchanged.

On the other hand, upon the application of a voltage to the signal electrode 4 in the selected line, the polar liquid 16 can move to change the display color on the display surface side, as described above.

In the image display apparatus 1, depending on the combination of the applied voltages shown in Table 3, the display color in each pixel in the selected line is CF color (red, green, or blue) due to the color filter 11r, 11g, or 11b or non-CF color (black) due to the polar liquid 16 in response to the voltage applied to the signal electrode 4 of the corresponding pixel, for example, as illustrated in FIG. 8. When the reference driver 8 and the scanning driver 9 sweep the selected lines of the reference electrode 5 and the scanning electrode 6, respectively, for example, from left to right in FIG. 8, the display color of each pixel on the display screen of the image display apparatus 1 sequentially changes from left to right in FIG. 8. Thus, the reference driver 8 and the scanning driver 9 can sweep the selected lines at a high speed to rapidly change the display color of each pixel on the display screen of the image display apparatus 1. Application of the signal voltage Vd to the signal electrode 4 in synchronism with the sweep of the selected line allows the image display apparatus 1 to display various items of information containing a dynamic image in response to the external image input signal.

The combinations of voltages applied to the reference electrodes 5, the scanning electrodes 6, and the signal electrodes 4 are not limited to those shown in Table 3 and may be those shown in Table 4.

TABLE 4

| | | | | Behavior of polar liquid |
|---|---|---|---|---|
| | Reference | Scanning | Signal | and display color on |
| | electrode | electrode | electrode | display surface side |
| Selected | L | H | L | Move toward scanning |
| line | | | | electrode |
| | | | | CF color display |
| | | | H | Move toward reference |
| | | | | electrode |
| | | | | Black display |
| Un- | M | M | H | At rest (No movement) |
| selected | | | L | Black or CF color |
| line | | | | display |

More specifically, the reference driver 8 and the scanning driver 9 sequentially apply the L voltage (second voltage) and the H voltage (first voltage) as the selective voltages to the reference electrodes 5 and the scanning electrodes 6 in a predetermined scanning direction, for example, from left to right in FIG. 8, thereby sweeping the selected line. In the selected line, the signal driver 7 applies the H voltage or the L voltage as the signal voltage Vd to the corresponding signal electrode 4 in response to the external image input signal.

The reference driver 8 and the scanning driver 9 apply the M voltage as the non-selective voltage to the unselected lines, that is, the remainder of the reference electrodes 5 and the scanning electrodes 6.

### <Operation in Selected Line>

When the L voltage is applied to the signal electrode 4 in the selected line, the L voltage is also applied between the reference electrode 5 and the signal electrode 4. Thus, no potential difference exists between the reference electrode 5 and the signal electrode 4. On the other hand, since the H voltage is applied to the scanning electrode 6, a potential difference exists between the signal electrode 4 and the scanning electrode 6. Thus, the polar liquid 16 moves in the display space S toward the scanning electrode 6, which has a potential difference from the signal electrode 4. Thus, the polar liquid 16 moves to the non-effective display area P2, as illustrated in FIG. 4(b). This moves the oil 17 toward the reference electrode 5 and allows illumination light of the backlight 18 to reach the color filter 11r. Thus, the display color on the display surface side is red display (CF color display) due to the color filter 11r. As shown in Table 1, CF color display in adjacent three RGB pixels results in white display.

When the H voltage is applied to the signal electrode 4 in the selected line, a potential difference exists between the reference electrode 5 and the signal electrode 4, and no potential difference exists between the signal electrode 4 and the scanning electrode 6. Thus, the polar liquid 16 moves in the display space S toward the reference electrode 5, which has a potential difference from the signal electrode 4. Thus, the polar liquid 16 moves to the effective display area P1, as illustrated in FIG. 4(a), and prevents illumination light of the backlight 18 from reaching the color filter 11r. Thus, the display color on the display surface side is black display (non-CF color display) due to the polar liquid 16.

### <Operation in Unselected Line>

When the L voltage is applied to the signal electrodes 4 in the unselected lines, the polar liquid 16 remains at rest and maintains the display color. More specifically, since the M voltage is applied to the reference electrodes 5 and the scanning electrodes 6, the potential difference between the reference electrodes 5 and the signal electrodes 4 is the same as the potential difference between the scanning electrodes 6 and the signal electrodes 4. Thus, the display color is not changed from black display or CF color display.

Likewise, when the H voltage is applied to the signal electrodes 4 in the unselected lines, the polar liquid 16 remains at rest and maintains the display color. More specifically, since the M voltage is applied to the reference electrodes 5 and the scanning electrodes 6, the potential difference between the reference electrodes 5 and the signal electrodes 4 is the same as the potential difference between the scanning electrodes 6 and the signal electrodes 4.

Thus, also with the combinations shown in Table 4, whether the signal electrodes 4 in the unselected lines have the H voltage or the L voltage, the polar liquid 16 remains at rest, and the display color on the display surface side remains unchanged, as shown in Table 1.

On the other hand, upon the application of a voltage to the signal electrode 4 in the selected line, the polar liquid 16 can move to change the display color on the display surface side, as described above.

In the image display apparatus 1 according to the present embodiment, in addition to the combinations of applied voltages shown in Tables 3 and 4, the voltage applied to the signal electrodes 4 may be an intermediate voltage between the H voltage and the L voltage depending on information to be displayed on the display surface, rather than the H voltage or the L voltage. Thus, in the image display apparatus 1, the signal voltage Vd can be controlled to produce gray-scale display. Thus, the display device 10 has excellent display performance.

In the display device 10 having such a structure according to the present embodiment, when the contact angle θ0 of the polar liquid 16 in the oil (insulating fluid) 17 is 150 degrees or more and 180 degrees or less to the water-repellent film (surface film) 15, the friction between the polar liquid 16 and the water-repellent film 15 can be greatly reduced, and the polar liquid 16 can move smoothly. In accordance with the present embodiment, therefore, the display device 10 can further improve the mobility of the polar liquid 16.

In the image display apparatus (electrical apparatus) 1 according to the present embodiment, the display screen includes the display device 10 that can further improve the mobility of the polar liquid 16. Thus, it is easy to provide the high-performance image display apparatus (electrical apparatus) 1 that includes the display screen having excellent display quality.

In the display device 10 according to the present embodiment, the signal driver (signal voltage applicator) 7, the reference driver (reference voltage applicator) 8, and the scanning driver (scanning voltage applicator) 9 apply the signal voltage Vd, the reference voltage Vr, and the scanning voltage Vs to the signal electrodes 4, the reference electrodes 5, and the scanning electrodes 6, respectively. Thus, the present embodiment can easily provide the matrix addressed display device 10 having excellent display quality and appropriately change the display color in each pixel region.

### Second Embodiment

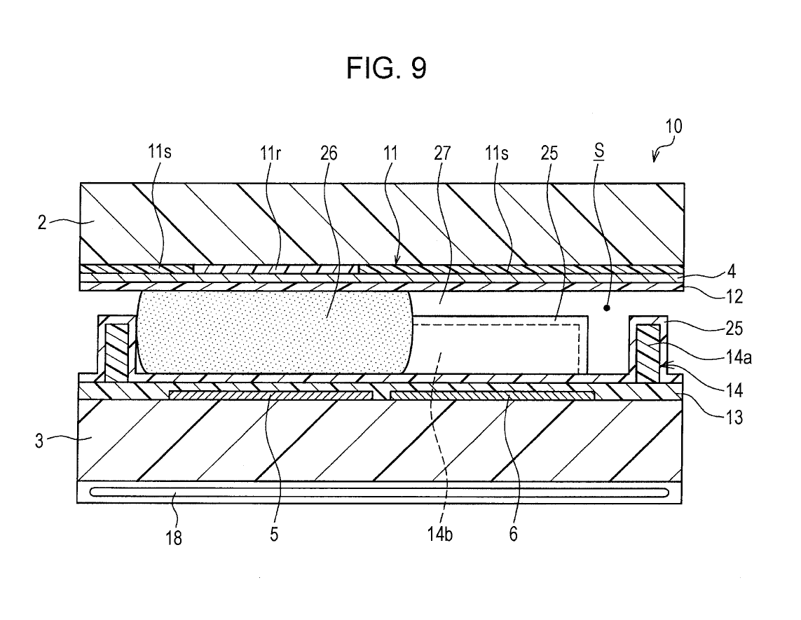

FIG. 9 is a cross-sectional view of a principal part of a display device according to a second embodiment of the present invention. In FIG. 9, a main point of difference between the present embodiment and the first embodiment is that the surface energy of the insulating fluid is brought close to the surface energy of the surface film. Components common to the present embodiment and the first embodiment are denoted by the same reference numerals and will not be further described.

In FIG. 9, a display device 10 according to the present embodiment includes a water-repellent film 25 as a surface film on the display space S side of a lower substrate 3. As in the first embodiment, each pixel region P contains a polar liquid 26 and an oil 27, which is an insulating fluid. The polar liquid 26 is immiscible with the oil 27. The water-repellent film 25, the polar liquid 26, and the oil 27 are selected such that the contact angle θ0 is 150 degrees or more and 180 degrees or less.

As in the first embodiment, the water-repellent film 25 and the oil 27 are selected such that the interfacial energy γf/o between the water-repellent film 25 and the oil 27 is 0 mN/m or more and less than 10 mN/m. The water-repellent film 25, the polar liquid 26, and the oil 27 are selected so as to satisfy the inequality (1). Thus, it is easy to set the contact angle θ0 at 150 degrees or more and 180 degrees or less and further improve the mobility of the polar liquid 26. The oil 27 is selected so as to satisfy the inequality (2). Thus, it is easy to set the contact angle θ0 at 150 degrees or more and 180 degrees or less and further improve the mobility of the polar liquid 26.

In the present embodiment, the oil 27 is selected such that the difference between the surface tension γo/a of the oil 27 and the surface tension γf/a,c of the water-repellent film 25 is within ±10 mN/m. Thus, in the display device 10 according to the present embodiment, the surface energy of the oil 27 is brought close to the surface energy of the water-repellent film 25 to easily set the contact angle θ0 at 150 degrees or more and 180 degrees or less.

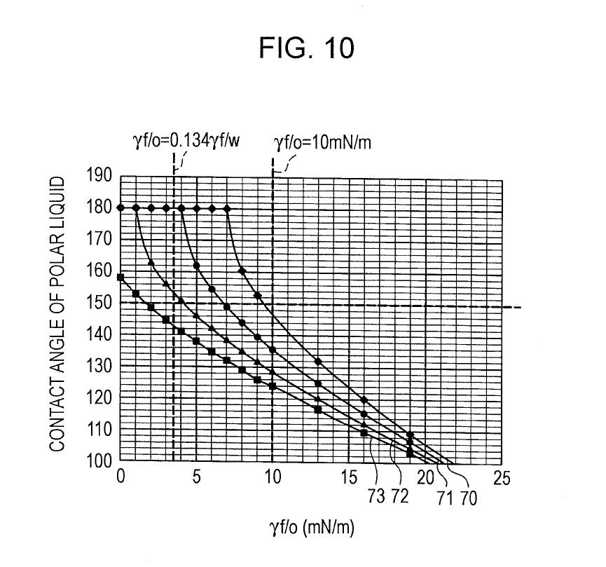

An example of experimental results for the display device 10 according to the present embodiment implemented by the present inventors will be more specifically described with reference to FIG. 10.

FIG. 10 is a graph showing the relationship between the interfacial energy between the water-repellent film 25 and the oil 27 and the contact angle of the polar liquid 26 in the display device illustrated in FIG. 9 when the surface energy of the oil 27 is changed and the interfacial energy between the polar liquid 26 and the water-repellent film 25 is held constant.

In this experiment, the polar liquid 26 and the water-repellent film 25 were made of ethylene glycol and amorphous polytetrafluoroethylene, respectively. The interfacial energy γf/w between the polar liquid 26 and the water-repellent film 25 was approximately 25 mN/m. The oil 27 was a fluoroalkylsiloxane. When the interfacial energy γf/o between the water-repellent film 25 and the oil 27 was reduced such that the surface energy of the oil 27 approached the surface energy of the water-repellent film 25 while the interfacial energy γw/o between the polar liquid 26 and the oil 27 was 18 mN/m, the contact angle θ0 of the polar liquid 16 increased as shown by a curve 70 in FIG. 10.

More specifically, when the interfacial energy γf/o was 9.5 mN/m, the contact angle θ0 was 150 degrees or more.

The fluorine atom content of the fluoroalkylsiloxane forming the oil 27 was increased to bring the surface energy of the oil 27 close to the surface energy of the water-repellent film 25. Curves 71, 72, and 73 are simulation results for an interfacial energy γw/o of 21, 24, and 27 mN/m, respectively. As is clear from the curves 71 to 73, when the interfacial energy γf/o is less than 10 mN/m, the contact angle θ0 can be more easily set at 150 degrees or more.

These experimental results also show that use of a fluorine-substituted compound in the water-repellent film 25 and addition of a fluorine compound to the oil 27 reduce the interfacial energy γf/o to less than 10 mN/m and increase the contact angle θ0 to 150 degrees or more.

In the present embodiment, the oil 27 may contain an at least partly fluorinated alkane or siloxane, such as perfluorooctane or the fluoroalkylsiloxane, as a suitable material.

Thus, the present embodiment can have the same effects and advantages as the first embodiment.

### Third Embodiment

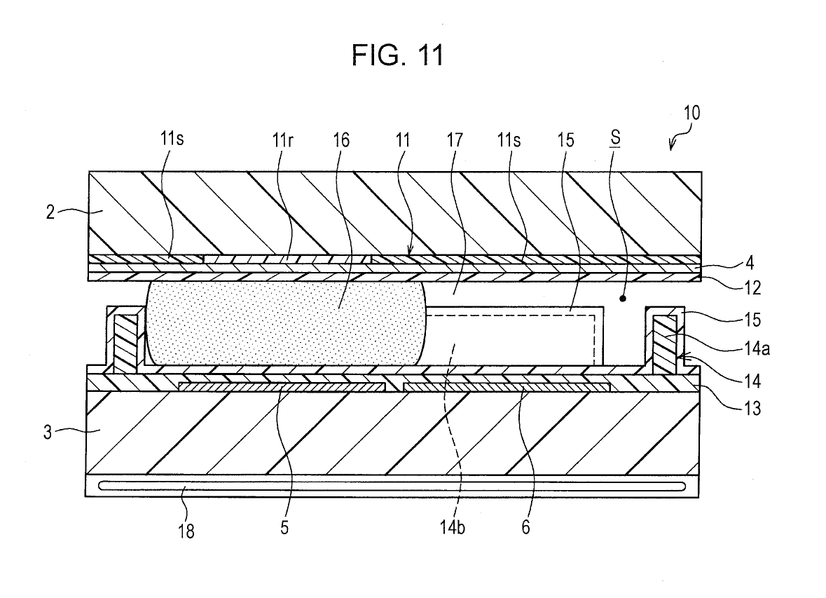

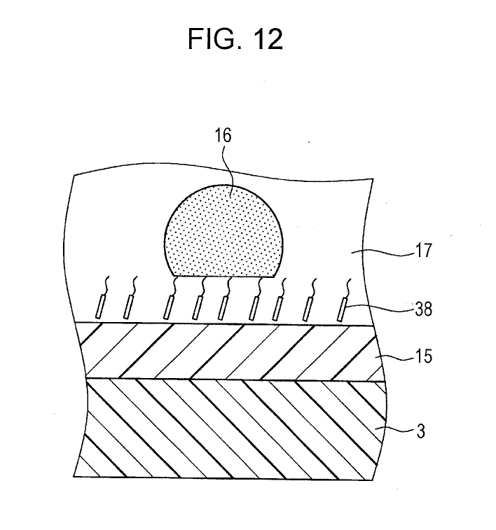

FIG. 11 is a cross-sectional view of a principal part of a display device according to a third embodiment of the present invention. FIG. 12 is an explanatory view of the state of a surfactant in the display device illustrated in FIG. 11. In the drawings, a main point of difference between the present embodiment and the first embodiment is that an additive agent that can be localized at an interface between a water-repellent film and the oil is added to an oil. Components common to the present embodiment and the first embodiment are denoted by the same reference numerals and will not be further described.

In a display device 10 according to the present embodiment illustrated in FIGS. 11 and 12, an additive agent 38 is added to an oil 17. As illustrated in FIG. 12, the additive agent 38 is characteristically localized at an interface between a water-repellent film 15 and the oil 17 (that is, a characteristic of a surfactant) and reduces the interfacial energy γf/o between the water-repellent film 15 and the oil 17. More specifically, the addition of the additive agent 38 reduces the interfacial energy γf/o to less than 10 mN/m. This ensures that the contact angle θ0 is 150 degrees or more and 180 degrees or less in the present embodiment and that the mobility of a polar liquid 16 is further improved.

Examples of the water-repellent film 15, the polar liquid 16, the oil 17, and the additive agent 38 according to the present embodiment will be more specifically described.

In the present embodiment, the water-repellent film 15, the polar liquid 16, and the oil 17 were made of a fluorine-containing polymer (more specifically, polytetrafluoroethylene), dodecane, and pure water, respectively. The interfacial energy γf/o between the water-repellent film 15 and the oil 17 was 6 mN/m, the interfacial energy γf/w between the water-repellent film 15 and the polar liquid 16 was 54 mN/m, and the interfacial energy γw/o between the polar liquid 16 and the oil 17 was 50 mN/m.

A highly fluorinated aliphatic alcohol having an affinity for both the water-repellent film 15 and the oil 17 (an amphiphilic compound, such as a compound represented by CₘF₂ₘ₊₁—CₙH₂ₙ—OH, m=8, n=12), for example, a perfluoroalkyl-alkyl was added as the additive agent 38 to the dodecane. The amount of highly fluorinated aliphatic alcohol was approximately 1% by weight of the fluid volume. The addition of the additive agent 38 slightly reduced the interfacial energy γf/o between the water-repellent film 15 and the oil 17 to 5 mN/m. This is probably because the additive agent 38 was localized at the interface between the water-repellent film 15 and the oil 17 to reduce the interfacial energy γf/o. Because of such a low interfacial energy γf/o, the polar liquid 16 had a large contact angle θ0 of 168 degrees. The interfacial energies γf/w and γw/o after the addition of the additive agent 38 were 54 and 50 mN/m, respectively, and were not changed by the addition of the additive agent 38.

Thus, the present embodiment can have the same effects and advantages as the first embodiment.

These embodiments are illustrative and not restrictive. The technical scope of the present invention is defined by the appended claims. All changes that fall within metes and bounds of the claims, or equivalence of such metes and bounds thereof are therefore intended to be included in the technical scope of the present invention.

For example, although the present invention is applied to an image display apparatus including a display screen in the above description, the present invention may be applied to any electrical apparatus that includes a display screen for displaying information containing letters and an image, for example, display apparatuses for personal digital assistants (PDAs), such as electronic notebooks, personal computers, and television sets, and various electrical apparatuses including a display screen, such as electronic papers.

Although electrowetting display devices in which a polar liquid moves in response to the application of an electric field to the polar liquid was described in the above description, display devices according to the present invention are not limited to these and may be any electric-field-induced display devices in which a polar liquid in a display space can move in the presence of an external electric field to change the display color on the display surface side, for example, other electric-field-induced display devices, such as electroosmotic, electrophoretic, and dielectrophoretic display devices.

Nevertheless, the polar liquid can move at higher speed at a lower driving voltage in electrowetting display devices as described in these embodiments. In electrowetting display devices, the display color changes with the movement of a polar liquid. Unlike liquid crystal displays that include a birefringent material, such as a liquid crystal layer, therefore, the electrowetting display devices are preferred because the electrowetting display devices can easily constitute high-intensity display devices having high light-use efficiency with respect to light from a backlight or extraneous light for use in information display. Furthermore, the electrowetting display devices can constitute a simple high-performance matrix addressed display device at low cost without providing a switching element in each pixel.

The display devices in the above description include signal electrodes, scanning electrodes, and reference electrodes, as well as a signal driver (signal voltage applicator), a scanning driver (scanning voltage applicator), and a reference driver (reference voltage applicator). The present invention, however, is not limited to these, provided that the contact angle of a polar liquid in an insulating fluid is 150 degrees or more and 180 degrees or less to a surface film.

More specifically, a plurality of signal electrodes and a plurality of scanning electrodes cross each other in a matrix form, and a switching element, for example, a thin-film transistor (TFT) is disposed in each of a plurality of pixel regions at the intersections of the signal electrodes and the scanning electrodes. A gate of the thin-film transistor is connected to one of the scanning electrodes, and a voltage is applied with the scanning voltage applicator. A source of the thin-film transistor is connected to one of the signal electrodes, and a voltage is applied with the signal voltage applicator. A drain of the thin-film transistor is connected to a pixel electrode disposed in each of the pixel regions. A voltage is supplied to the thin-film transistor through the signal electrode to move a polar liquid.

Nevertheless, a display device that includes reference electrodes and a reference driver (reference voltage applicator) as in the embodiments described above is preferred because the display device can constitute a matrix addressed display device that can prevent display defects without providing a switching element in each pixel region.

Although the transmissive display device that includes the backlight is described in the above description, the present invention is not limited to this. The present invention may be applied to a reflective display device that includes a light reflector, such as a diffuse reflector, or a transflective display device that includes both the light reflector and a backlight.

Although the polar liquid was pure water in the above description, the polar liquid in the present invention is not limited to this. More specifically, the polar liquid may be one containing an electrolyte, such as potassium chloride, zinc chloride, potassium hydroxide, sodium hydroxide, an alkali metal hydroxide, zinc oxide, sodium chloride, a lithium salt, phosphoric acid, an alkali metal carbonate, or an oxygen ion conducting ceramic. Instead of water, an organic solvent, such as an alcohol, acetone, formamide, or ethylene glycol, may be used as a solvent. A polar liquid in the present invention may be an ionic liquid (ambient temperature molten salt) that contains a cation, such as pyridine, an alicyclic amine, or an aliphatic amine, and an anion, such as a fluorinated anion, including a fluoride ion or a triflate.

A polar liquid in the present invention includes an electrically conductive liquid and a high-dielectric liquid having at least a predetermined relative dielectric constant, preferably a relative dielectric constant of 15 or more.

Nevertheless, as in the embodiments described above, use of an aqueous solution of a predetermined electrolyte as a polar liquid is preferred because the aqueous solution is easy to handle and can easily constitute a display device that is easy to manufacture.

Although a nonpolar oil is used in the above description, the present invention is not limited to this. Instead of the oil, an insulating fluid immiscible with a polar liquid, for example, air, more specifically, a noble gas, such as helium, neon, or argon, or nitrogen may be used. The oil may be a silicone oil or an aliphatic hydrocarbon. An insulating fluid in the present invention includes a fluid having not more than a predetermined relative dielectric constant, preferably a relative dielectric constant of 5 or less.

Nevertheless, as in the embodiments described above, use of a nonpolar oil immiscible with a polar liquid is preferred to use of air and a polar liquid because a droplet of the polar liquid can more easily move in the nonpolar oil, and the polar liquid can move rapidly to change the display color at high speed.

In the above description, the signal electrodes are disposed on top of the upper substrate (first substrate), and the reference electrodes and the scanning electrodes are disposed on top of the lower substrate (second substrate). In the present invention, however, the signal electrodes may be disposed in contact with a polar liquid in the display space, and the polar liquid and the reference electrodes and the scanning electrodes may be disposed on top of one of the first and second substrates while the reference electrodes and the scanning electrodes are electrically insulated from each other. More specifically, for example, the signal electrodes may be disposed at an intermediate portion between the first and second substrates, and the reference electrodes and the scanning electrodes may be disposed on top of the first substrate.

Although the reference electrodes and the scanning electrodes are disposed in the effective display area and the non-effective display area, respectively, in the above description, the present invention is not limited to this. The reference electrodes and the scanning electrodes may be disposed in the non-effective display area and the effective display area, respectively.

Although the reference electrodes and the scanning electrodes are disposed on the display surface side of the lower substrate (second substrate) in the above description, the present invention is not limited to this. The reference electrodes and the scanning electrodes may be embedded in the second substrate made of an insulating material. In this case, the second substrate may also serve as a dielectric layer, which obviates the necessity of forming another dielectric layer. Furthermore, the signal electrodes may be directly disposed on the first and second substrates, which also serve as dielectric layers, and the signal electrodes may be disposed in the display space.

Although a transparent electrode material is used to form the reference electrodes and the scanning electrodes in the above description, either the reference electrodes or the scanning electrodes that face the effective display area in each pixel may be made of the transparent electrode material, and the other of the reference electrodes and the scanning electrodes not facing the effective display area may be made of an opaque electrode material, such as aluminum, silver, chromium, or another metal.

Although the reference electrodes and the scanning electrodes arranged in stripes are used in the above description, the shape of each of the reference electrodes and the scanning electrodes in the present invention is not limited to this. For example, a reflective display device that has lower light-use efficiency in information display than a transmissive display device may have a linear or network shape, which rarely causes optical loss.

Although the signal electrodes are linear electric wires in the above description, the signal electrodes in the present invention are not limited to this and may be electric wires having another shape, such as network electric wires.

Although each RGB pixel is provided on the display surface side using a black polar liquid and a color filter layer in the above description, the present invention is not limited to this. A plurality of pixel regions may be provided for each of a plurality of colors for full-color display on the display surface side. More specifically, polar liquids of different colors, such as RGB, cyan (C), magenta (M), and yellow (Y), that is, CMY, or RGBYC may be used.

Although the color filter layer is disposed on the non-display surface side of the upper substrate (first substrate) in the above description, the present invention is not limited to this. The color filter layer may be disposed on the display surface side of the first substrate or the lower substrate (second substrate) side. Use of a color filter layer is preferred to use of polar liquids of different colors because the use of a color filter layer can easily constitute a display device that is easy to manufacture. Use of a color filter layer is also preferred because the effective display area and the non-effective display area are properly and reliably provided in the display space using color filters (openings) and a black matrix (light-shielding film) in the color filter layer.

### INDUSTRIAL APPLICABILITY

The present invention is useful for a display device that can further improve the mobility of a polar liquid and an electrical apparatus including the display device.

### REFERENCE SIGNS LIST

1 image display apparatus (electrical apparatus)
2 upper substrate (first substrate)
3 lower substrate (second substrate)
4 signal electrode
5 reference electrode
6 scanning electrode
7 signal driver (signal voltage applicator)
8 reference driver (reference voltage applicator)
9 scanning driver (scanning voltage applicator)
10 display device
11 color filter layer
11r, 11g, 11b color filters (openings)
11s black matrix (light-shielding film)
13 dielectric layer
14 rib
14a first rib member
14b second rib member
15, 25 water-repellent film (surface film)
16, 26 polar liquid
17, 27 oil (insulating fluid)
38 additive agent
   S display space
   P pixel region
P1 effective display area
P2 non-effective display area
θ0 contact angle

1. A display device, comprising: a first substrate disposed on a display surface side; a second substrate disposed on a non-display surface side and facing the first substrate, the second substrate and the first substrate forming a predetermined display space therebetween; an effective display area and a non-effective display area in the display space; and a polar liquid that is movable toward the effective display area or the non-effective display area in the display space, wherein the polar liquid can be moved to change the display color on the display surface side,
the display device further including
a plurality of signal electrodes in contact with the polar liquid in the display space and arranged in a predetermined direction,
a plurality of scanning electrodes disposed on top of one of the first and second substrates on one of the effective display area side and the non-effective display area side, the scanning electrodes being electrically insulated from the polar liquid and crossing the signal electrodes,
an insulating fluid that is movable in the display space and is immiscible with the polar liquid, and
a surface film disposed on the display space side on top of one of the first and second substrates on which the scanning electrodes are disposed,
wherein the polar liquid in the insulating fluid has a contact angle of 150 degrees or more and 180 degrees or less to the surface film.

2. The display device according to claim 1, wherein the surface film (F) and the insulating fluid (O) are selected such that the interfacial energy γf/o between the surface film (F) and the insulating fluid (O) is 0 mN/m or more and less than 10 mN/m.

3. The display device according to claim 1, wherein the surface film (F), the insulating fluid (O), and the polar liquid (W) are selected such that the interfacial energy γf/o between the surface film (F) and the insulating fluid (O) and the interfacial energy γf/w between the surface film (F) and the polar liquid (W) satisfy the following inequality (1).
γf/o≦0.134×γf/w (1)

4. The display device according to claim 1, wherein the insulating fluid (O) is selected such that the interfacial energy γw/o between the insulating fluid and the polar liquid (W) and the interfacial energy γf/w between the surface film (F) and the polar liquid (W) satisfy the following inequality (2).
γw/o≦1.15×γf/w (2)

5. The display device according to claim 1, wherein the surface film (F) is selected such that the difference between the surface tension γf/a,c between the surface film (F) and air (A) (wherein c denotes the critical surface tension of the surface film (F)) and the surface tension γo/a between the insulating fluid (O) and air (A) is within ±10 mN/m.

6. The display device according to claim 1, wherein the insulating fluid (O) is selected such that the difference between the surface tension γf/a,c between the surface film (F) and air (A) (wherein c denotes the critical surface tension of the surface film (F)) and the surface tension γo/a between the insulating fluid (O) and air (A) is within ±10 mN/m.

7. The display device according to claim 1, wherein an additive agent that can be localized at an interface between the surface film and the insulating fluid is added to the insulating fluid.

8. The display device according to claim 1, further comprising: a signal voltage applicator that is connected to the signal electrodes and applies a signal voltage to each of the signal electrodes in a predetermined voltage range depending on information to be displayed on the display surface side; and a scanning voltage applicator that is connected to the scanning electrodes and applies a selective voltage or a non-selective voltage to each of the scanning electrodes depending on the signal voltage, the selective voltage allowing the polar liquid to move in the display space, the non-selective voltage preventing the polar liquid from moving in the display space.

9. The display device according to claim 1, further comprising a plurality of pixel regions on the display surface side, wherein the pixel regions are disposed at their respective intersections between the signal electrodes and the scanning electrodes, and the display space in the pixel regions is defined by partitions.

10. The display device according to claim 9, wherein the pixel regions are provided for each of a plurality of colors for full-color display on the display surface side.

11. The display device according to claim 1, further comprising:
a plurality of reference electrodes disposed on top of one of the first and second substrates on the other of the effective display area side and the non-effective display area side, the reference electrodes being electrically insulated from the polar liquid and the scanning electrodes and crossing the signal electrodes; and
a reference voltage applicator that is connected to the reference electrodes and applies a selective voltage or a non-selective voltage to each of the reference electrodes depending on the signal voltage, the selective voltage allowing the polar liquid to move in the display space, the non-selective voltage preventing the polar liquid from moving in the display space.

12. The display device according to claim 11, further comprising a dielectric layer on the reference electrodes and the scanning electrodes.

13. The display device according to claim 1, wherein the non-effective display area is provided by a light-shielding film disposed on one of the first and second substrate sides, and the effective display area is provided by an opening in the light-shielding film.

14. An electrical apparatus, comprising a display screen for displaying information including letters and an image, wherein the display screen includes the display device according to claim 1.
